(19) United States
(12) Patent Application Publication
(10) Pub. No.: US 2006/0119734 A1
(43) Pub. Date: Jun. 8, 2006

(54) Docking station for near-object digital photography

(75) Inventor: John C. Neel, Pittsford, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/004,243

(22) Filed: Dec. 3, 2004

(51) Int. Cl. H04N 5/225

(52) U.S. Cl. 348/375

(57) ABSTRACT

A docking station is provided. The docking station has a base with a digital camera receiving area adapted to position a digital camera so that the digital camera is directed at an object mount. The object mount is adapted to position a subject object at a distance of less than one meter from a lens system of the digital camera. A communication circuit is adapted to exchange data between the dock controller and a camera controller in the digital camera when the digital camera is in the digital camera receiving area. The exchange of data causes the camera controller to adapt a setting of an image capture system in the camera for the capture of an image of the subject object.

### FIELD OF THE INVENTION

The present embodiments relate to a docking station for near-image digital photography.

### BACKGROUND OF THE INVENTION

Since the early days of photography, slides have been used to capture beautiful images on light transmissive mediums and to document important paintings and critical events. Millions of slides, negatives and microfilms are still in existence and contain a wealth of important medical, scientific, commercial and historical information. A variety of conventional scanning systems are known for scanning and converting slides, negatives and other forms of images that are recorded on a light transmissive medium into a digital form. These scanning systems involve the use of expensive computer based peripherals that typically require more than an initial level of computer expertise. Accordingly, a need exists for an inexpensive system that enables consumers and archivists to easily transfer these slides, negatives, microfilms and other forms of information recorded on transmissive mediums to a digital format.

A related image capture need is for an image capture system that enables a user to easily capture images of photographic subjects for which high quality close-up image capture and/or backlit image capture is desirable. Examples of photographic subjects of this type include, but are not limited to, objects such as photographs, collectable cards, coins, gemstones and the like. While a variety of systems are known in the art to facilitate such near object photography, such systems are complex, expensive and require advanced knowledge of camera settings, such as exposure requirements. Accordingly, such systems are typically not well suited for users who simply wish to easily capture quality images of near objects.

### SUMMARY OF THE INVENTION

In one aspect of the invention, a docking station is provided. The docking station has a base with a digital camera receiver adapted to position a digital camera so that the digital camera is directed at an object mount. The object mount adapted to position a subject object at a distance of less than one meter from a lens system of the digital camera. A communication circuit is adapted to exchange data between the dock controller and a camera controller in the digital camera when the digital camera is in the digital camera receiving area. The exchange of data causes the camera controller to adapt a setting of an image capture system in the camera for the capture of an image of the subject object.

In another aspect of the invention, a docking station is provided for capturing an image of an image recorded on a light transmissive medium. The docking station has a base with a first end and a second end, and an object mount connected to the base between the first and second end. The object mount has a holding frame that is adapted to hold the light transmissive medium. A light source is at the first end, and is adapted to illuminate the object mount in an area where the object mount will hold the transmissive medium. A digital camera receiving area at the second end is adapted to position the digital camera so that the digital camera is positioned to capture an image of the image recorded on the transmissive medium in the object mount. A communication circuit is adapted to enable data to be exchanged between a digital camera controller in the digital camera and a base controller. The base controller and digital camera controller are adapted to exchange data and to use the exchanged data to cause the light source to illuminate the image on the light transmissive medium and to cause the digital camera to be set to capture an image of the image on the light transmissive medium.

In still another aspect of the invention, a docking station is provided for transferring images on light transmissive mediums using a digital camera. The docking station has a base connected to a power source, an object mount connected to the base adapted to hold a light transmissive medium having an image recorded thereon, a light source disposed within the base adapted to illuminate the image on a light transmissive medium, and a stand comprising a top end and a bottom end, wherein the bottom end is connected to the base. A digital camera is connected to the top end. The digital camera is positioned to capture an image of the image on a light transmissive medium illuminated in the object mount. A controller is connected to the base, wherein the controller is adapted to perform at least three operations: a first operation to cause the digital camera to set up an image capture system to capture the image of an image on the light transmissive medium; a second operation to illuminate the image on a light transmissive medium using the light source; and a third operation to allow the digital camera to communicate with an output device once the image on a light transmissive medium is captured digitally.

In a further aspect of the invention, a docking station for use with a digital camera is provided. The imaging docking station has a base means with a digital camera receiving means for directing a digital camera at an object mount means, with the object mount means for positioning a subject object at a distance of less than one meter from an image capture means of the digital camera. A communication means is provided for exchanging data between a dock control means and a camera control means in the digital camera. Wherein the exchange of data causes the camera control means to adapt the image capture means in the digital camera for the capture of an image of the subject object.

### BRIEF DESCRIPTION OF THE DRAWINGS

In the detailed description of the preferred embodiments presented below, reference is made to the accompanying drawings, in which:

FIG. 1 shows a block diagram, an example embodiment of a digital camera and docking station;

FIG. 2 shows a backview of the digital camera of claim 1;

FIG. 3 provides an embodiment of a docking station;

FIG. 4 depicts a side view of an object mount usable in the docking station;

FIG. 5 depicts a front view of the object mount of FIG. 4;

FIG. 6 is a side view of a vertical mounted embodiment of the object mount and the docking station;

FIG. 7 depicts another embodiment of the object mount holder; and

FIG. 8 shows another embodiment of a docking station of the invention having a dock optical system.

The present embodiments are detailed below with reference to the listed Figures.

### DETAILED DESCRIPTION OF THE INVENTION

Before explaining the present embodiments in detail, it is to be understood that the embodiments are not limited to the particular descriptions and that it can be practiced or carried out in various ways.

In one aspect of the invention, a docking station is provided that enables simple and effective image capture of near image objects such slides using a digital camera. Accordingly, images are not scanned, but are imaged all at once. Thus, the process for capturing a digital image from a slide is many times faster than traditional scanning processes. Further, the docking station is adapted to cooperate with the digital camera so that the user of the digital camera need not make complex adjustments to the camera in order to enable near image and/or backlit photography. Accordingly, as will be described in greater detail below, in various embodiments, once that the digital camera is positioned in the docking station photography of the near image object will be a simple as conventional photography and will be executable by someone who is knowledgeable in the operation of the digital camera without any specific knowledge of the concepts of near image photography. The docking station can have an integral printer or be connected to a remote printer to allow users to capture and print digital images in a convenient fashion. Accordingly, near image photography can be executed for printing, sharing, or archiving with low cost, ease of use, and with few maintenance issues.

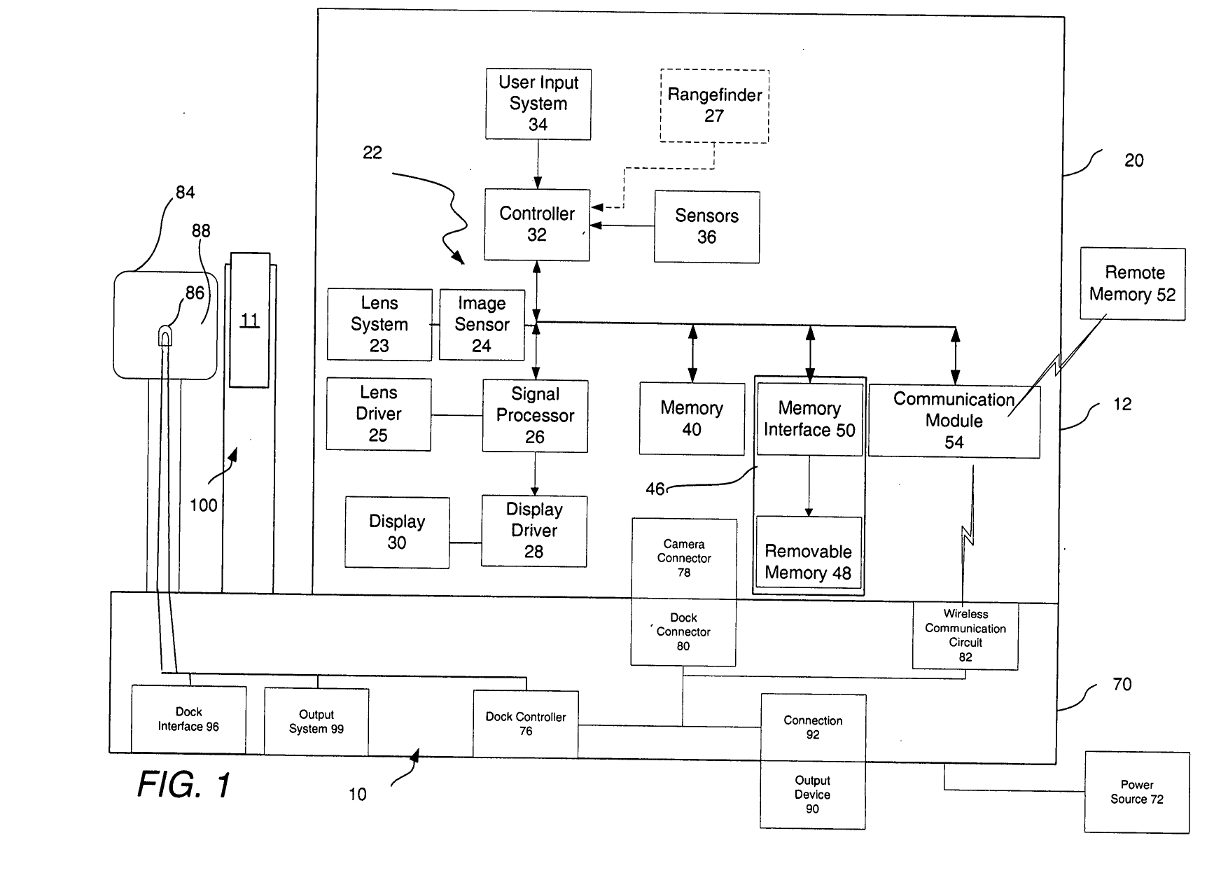

FIG. 1 shows a block diagram of one embodiment of a docking station 10 of the present invention in combination with a digital camera 12 for capturing digital images of a subject object 11. As shown in FIG. 1, digital camera 12 comprises a body 20 that houses an image capture system 22 having a lens system 23, an image sensor 24, a signal processor 26, an optional display driver 28 and a display 30. In operation, light from a scene is focused by lens system 23 to form an image on image sensor 24. Lens system 23 can have one or more elements.

Lens system 23 can be of a fixed focus type or can be manually or automatically adjustable. Lens system 23 can be simple, such as having a single focal length or the focal length can be adjustable. In the embodiment shown in FIG. 1, lens system 23 is automatically adjusted with taking lens system 23 comprising a 6× zoom lens unit in which a mobile element or elements (not shown) are driven, relative to a stationary element or elements (not shown) by a motorized lens driver 25. Lens driver 25 can control a lens focal length and/or a lens focus position of lens system 23 and sets a lens focal length and/or lens focus position based upon signals from signal processor 26, an optional automatic range finder system 27, and/or camera controller 32.

The focus position of lens system 23 can be automatically selected using a variety of known strategies including digital through focusing techniques. Alternatively, as shown in FIG. 1, digital camera 12 can comprise optional range finder 27 which can be, for example, of an optical or ultrasonic type. A feedback loop is established between lens driver 25 and camera controller 32 so that camera controller 32 can accurately set the focus position of lens system 23.

Lens system 23 is also optionally adjustable to provide a variable zoom. In the embodiment shown, lens driver 25 automatically adjusts the position of one or more mobile elements (not shown) relative to one or more stationary elements (not shown) of lens system 23 based upon signals from signal processor 26, optional range finder 27, and/or camera controller 32 to provide a zoom magnification. Lens system 23 can be of a fixed magnification, manually adjustable and/or can employ other known arrangements for providing an adjustable zoom.

Light from the scene that is focused by lens system 23 onto image sensor 24 is converted into image signals representing an image of the scene. Image sensor 24 can comprise a charge couple device (CCD), a complimentary metal oxide sensor (CMOS), or any other electronic image sensor known to those of ordinary skill in the art. The image signals can be in digital or analog form.

Signal processor 26 receives image signals from image sensor 24 and transforms the image signals into an image in the form of digital data. The digital image can comprise one or more still images, and/or a stream of apparently moving images such as a video segment. Where the digital image data comprises a stream of apparently moving images, the digital image data can comprise image data stored in an interleaved or interlaced image form, a sequence of still images, and/or other forms known to those of skill in the art of digital video.

Signal processor 26 can apply various image processing algorithms to the image signals when forming a digital image. These can include but are not limited to color and exposure balancing, interpolation and compression. Where the image signals are in the form of analog signals, signal processor 26 also converts these analog signals into a digital form. In certain embodiments of the invention, signal processor 26 can be adapted to process signals from image sensor 24 so that the digital image formed thereby appears to have been captured at a different zoom setting than that actually provided by the lens system 23. This can be done by using a subset of the image signals from image sensor 24 and interpolating the subset of the image signals to form the digital image. This is known generally in the art as “digital zoom”. Such digital zoom can be used to provide electronically controllable zoom adjusted digital images in a digital camera 12 with a lens system 23 having a fixed focal length, manual focal length, or an automatically adjustable focal length lens system 23.

Camera controller 32 controls the operation of digital camera 12 during imaging operations, including but not limited to image capture system 22, display 30 and memory such as memory 40. Camera controller 32 causes image sensor 24, signal processor 26, display 30 and memory 40 to capture present, and/or store original images in response to signals received from a user input system 34, data from signal processor 26 and data received from optional sensors 36 and, as will be described in greater detail below, data from an external controller or other source. Camera controller 32 can comprise a microprocessor such as a programmable general-purpose microprocessor, a dedicated microprocessor or micro-controller, a combination of discrete components or any other system that can be used to control operation of digital camera 12.

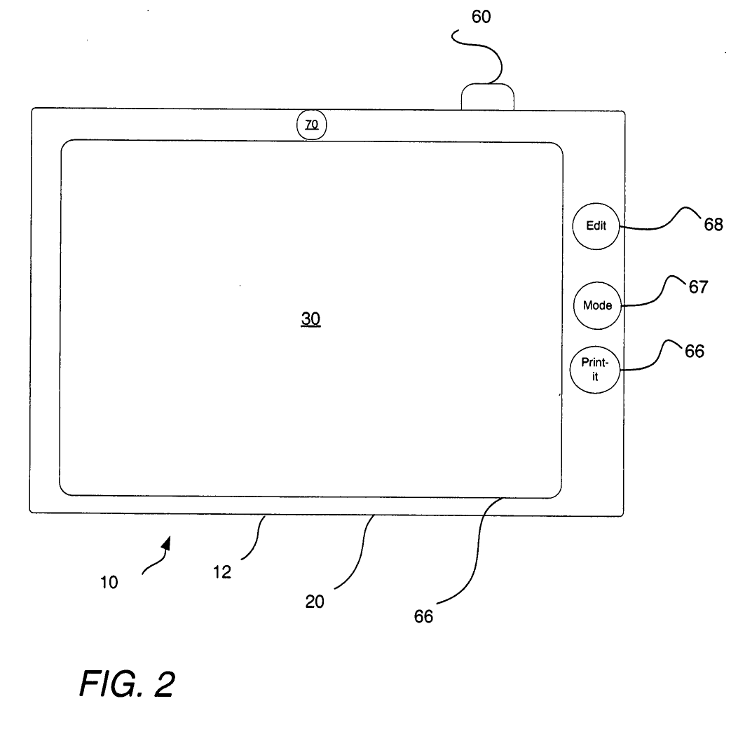

Controller 32 cooperates with a user input system 34 to allow digital camera 12 to interact with a user. User input system 34 can comprise any form of transducer or other device capable of receiving an input from a user and converting this input into a form that can be used by camera controller 32 in operating digital camera 12. For example, user input system 34 can comprise a touch screen input, a touch pad input, a 4-way switch, a 6-way switch, an 8-way switch, a stylus system, a trackball system, a joystick system, a voice recognition system, a gesture recognition system or other such systems. In the embodiment of digital camera 12, shown in FIGS. 1 and 2, user input system 34 includes a capture button 60 that sends a trigger signal to camera controller 32 indicating a desire to capture an image. User input system 34 can also include other buttons including a mode selector button 64, a print-it button 66 and an edit button 68 shown in FIG. 2.

Sensors 36 are optional and can include light sensors and other sensors known in the art that can be used to detect conditions in the environment surrounding digital camera 12 and to convert this information into a form that can be used by camera controller 32 in governing operation of digital camera 12. Sensors 36 can include audio sensors adapted to capture sounds. Such audio sensors can be of conventional design or can be capable of providing controllably focused audio capture such as the audio zoom system described in U.S. Pat. No. 4,862,278, entitled “Video Camera Microphone with Zoom Variable Acoustic Focus”, filed by Dann et al. on Oct. 14, 1986. Sensors 36 can also include biometric sensors adapted to detect characteristics of a user for security and affective imaging purposes. Further, sensors 36 can include light sensors that are adapted to sense exposure conditions in a scene and to provide data to camera controller 32 so that camera controller 32 can make exposure settings or determine a need for artificial illumination in a scene. Where a need for artificial illumination is determined based upon a signal from an illumination type sensor 36, camera controller 32 can cause a scene illumination system 84 such as a light, strobe, or flash system to emit light.

Camera controller 32 generates a capture signal which causes a corresponding digital image to be captured when a trigger condition is detected. Typically, the trigger condition occurs when camera controller 32 detects a trigger signal indicating that a user has depressed capture button 60. However, camera controller 32 can determine that a trigger condition exists at a particular time, or at a particular time after capture button 60 is depressed. Alternatively, camera controller 32 can determine that a trigger condition exists when optional sensors 36 detect certain environmental conditions, such as optical or radio frequency signals. Further camera controller 32 can determine that a trigger condition exists based upon affective signals obtained from the physiology of a user. As will be discussed in greater detail below, camera controller 32 can determine that a trigger condition exists when camera controller 32 receives certain signals from a docking station 10.

Camera controller 32 can also be used to generate metadata in association with each image. Metadata is data that is related to a digital image or a portion of a digital image but that is not necessarily observable in the image itself. In this regard, camera controller 32 can receive signals from signal processor 26, from camera user input system 34, from sensors 36 or from docking station 10 and, optionally, generate metadata based upon such signals. The metadata can include but is not limited to information such as the time, date and location that the original image was captured, the type of image sensor 24, mode setting information, integration time information, taking lens unit setting information that characterizes the process used to capture the original image and processes, methods and algorithms used by digital camera 12 to form the original image. The metadata can also include but is not limited to any other information determined by camera controller 32 or stored in any memory in digital camera 12 such as information that identifies digital camera 12, and/or instructions for rendering or otherwise processing the digital image with which the metadata is associated. The metadata can also comprise an instruction to incorporate a particular message into digital image when presented. Such a message can, for example, be a text message to be rendered when the digital image is rendered. The metadata can also include audio signals. The metadata can further include digital image data. In one embodiment of the invention, where digital zoom is used to form the digital image from a subset of the captured image, the metadata can include image data from portions of an image that are not incorporated into the subset of the digital image that is used to form the digital image. The metadata can also include any other information entered into digital camera 12 or supplied to digital camera 12 by way of docking station 10.

The digital images and optional metadata, can be stored in a compressed form. For example where the digital image comprises a sequence of still images, the still images can be stored in a compressed form such as by using the JPEG (Joint Photographic Experts Group) ISO 10918-1 (ITU-T.81) standard. This JPEG compressed image data is stored using the so-called “Exif” image format defined in the Exchangeable Image File Format version 2.2 published by the Japan Electronics and Information Technology Industries Association JEITA CP-3451. Similarly, other compression systems such as the MPEG-4 (Motion Pictures Export Group) or Apple QuickTime™ standard can be used to store digital image data in a video form. Other image compression and storage forms can be used.

The digital images and metadata can be stored in a memory such as memory 40. Memory 40 can include conventional memory devices including solid state, magnetic, optical or other data storage devices. Memory 40 can be fixed within digital camera 12 or it can be removable. In the embodiment of FIG. 1, digital camera 12 is shown having a memory card slot 46 that holds a removable memory 48 such as a removable memory card and has a removable memory interface 50 for communicating with removable memory 48. The digital images and metadata can also be stored in a remote memory system 52 that is external to digital camera 12 such as a personal computer, computer network or other imaging system.

In the embodiment shown in FIGS. 1 and 2, digital camera 12 has a communication module 54 for communicating with remote memory system 52 or other devices. The communication module 54 can be for example, an optical communication system, a radio frequency communication system or some other transducer system that converts image and other data into a form that can be conveyed to a remote device by way of an optical signal, radio frequency signal or other form of signal. Communication module 54 can also be used to receive a digital image and other information from a host computer or network (not shown). Camera controller 32 can also receive information and instructions from signals received by communication module 54 including but not limited to, signals from a remote control device (not shown) such as a remote trigger button (not shown) and can operate image capture system 22 in accordance with such signals.

Signal processor 26 and/or camera controller 32 are also adapted to form evaluation images which have an appearance that corresponds to a captured original image stored in digital camera 12 and that are further adapted for presentation on display 30. This allows users of digital camera 12 to view the evaluation images. Such original images can include, for example, images that have been captured by image capture system 22, and/or that were otherwise obtained such as by way of communication module 54 and/or stored in a memory such as memory 40 or removable memory 48.

Display 30 can comprise, for example, a color liquid crystal display (LCD), organic light emitting display (OLED) also known as an organic electro-luminescent display (OELD) or other type of video display. Display 30 can be external as is shown in FIG. 2, or it can be internal for example used in a viewfinder system 38. Alternatively, digital camera 12 can have more than one display 30 with, for example, one being external and one internal. Display 30 can be separate or separable from body 20 with wired or wireless communication schemes provided to enable communication between controller 32 and such a separate or separable type of display 30.

Signal processor 26 and/or camera controller 32 can also cooperate to generate other images such as text, graphics, icons and other information for presentation on display 30 that can allow interactive communication between camera controller 32 and a user of digital camera 12, with display 30 providing information to the user of digital camera 12 and the user of digital camera 12 using user input system 34 to interactively provide information to digital camera 12. Digital camera 12 can also have other displays such as a segmented LCD or LED display (not shown) which can also permit signal processor 26 and/or camera controller 32 to provide information to a user. This capability is used for a variety of purposes such as establishing modes of operation, entering control settings, user preferences, and providing warnings and instructions to a user of digital camera 12. Other systems such as known systems and actuators for generating audio signals, vibrations, haptic feedback and other forms of signals can also be incorporated into digital camera 12 for use in providing information, feedback and warnings to the user of digital camera 12.

Typically, display 30 has less imaging resolution than image sensor 24. Accordingly, signal processor 26 reduces the resolution of an original image when forming evaluation images adapted for presentation on display 30. Down sampling and other conventional techniques for reducing the overall imaging resolution can be used. For example, resampling techniques such as are described in commonly assigned U.S. Pat. No. 5,164,831 “Electronic Still Camera Providing Multi-Format Storage Of Full And Reduced Resolution Images” filed by Kuchta et al. on Mar. 15, 1990, can be used. The evaluation images can optionally be stored in a memory such as memory 40. The evaluation images can be adapted to be provided to an optional display driver 28 that can be used to drive display 30. Alternatively, the evaluation images can be converted into signals that can be transmitted by signal processor 26 in a form that directly causes display 30 to present the evaluation images. Where this is done, display driver 28 can be omitted.

Imaging operations that can be used to obtain an original image using image capture system 22 of digital camera 12 include a capture process and can optionally also include a composition process and a verification process.

During the composition process, camera controller 32 provides an electronic viewfinder effect on display 30. In this regard, camera controller 32 and/or signal processor 26, cooperate with image sensor 24, user interface 96 and sensors 36 to determine settings for image capture system 22, to capture preview digital images and to present corresponding evaluation images on display 30.

In the embodiment shown in FIGS. 1 and 2, camera controller 32 enters the image composition process when capture button 60 is moved to a half depression position. However, other methods for determining when to enter a composition process can be used. For example, edit button 68 shown in FIG. 2 can be depressed by a user of digital camera 12, and can be interpreted by camera controller 32 as an instruction to enter the composition process. The evaluation images presented during composition can help a user to compose the scene for the capture of an original image.

In the embodiment of FIGS. 1 and 2, a capture process can begin when capture button 60 is moved to a full depression condition wherein it generates a trigger signal. Camera controller 32 determines that a trigger condition exists when camera controller 32 detects the trigger signal. Camera controller 32 sends a capture signal causing signal processor 26 to obtain image signals from image sensor 24 and to process the image signals to form digital image data comprising an archival digital image.

During the verification process, an evaluation image corresponding to the original digital image is optionally formed for presentation on display 30 by signal processor 26. In one alternative embodiment, signal processor 26 converts each image signal into a digital image and then derives the corresponding evaluation image from the archival digital image. The corresponding evaluation image is supplied to display 30 and is presented for a period of time. This permits a user to verify that the archival digital image has a preferred appearance.

Original images can also be obtained by digital camera 12 in ways other than image capture. For example, original images can by conveyed to digital camera 12 when such images are recorded on a removable memory that is operatively associated with memory interface 50. Alternatively, original images can be received by way of communication module 54. For example, where communication module 54 is adapted to communicate by way of a cellular telephone network, communication module 54 can be associated with a cellular telephone number or other identifying number that for example another user of the cellular telephone network such as the user of a telephone equipped with a digital camera can use to establish a communication link with digital camera 12 and transmit images which can be received by communication module 54.

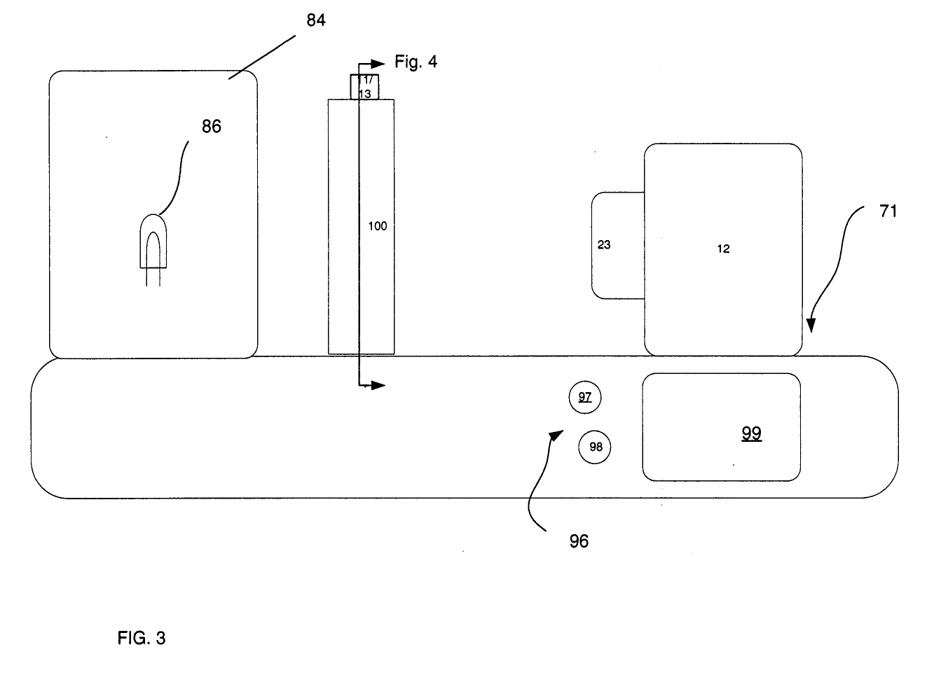

As is shown in FIGS. 1-3, docking station 10 comprises a base 70 connected to a power source 72. In the embodiment shown in FIGS. 1-3 docking station 10 and digital camera 12 are separate units that are joined for cooperation. However, in certain embodiments digital camera 12 can be integrated into base 70 so that docking station 10 is a self-contained unit.

Base 70 is typically made of durable material, such as molded plastic or metal. As an example, one version of the docking station can have a base 70 with a height ranging from 0.5 inch to 4 inches, a width ranging from 3 inches to 7 inches, and a length ranging from 6 inches to 12 inches. The compact version allows docking station 10 to be used on any conventional table and without the need for additional equipment or stands.

Base 70 has a dock controller 76. Dock controller 76 can comprise a microprocessor, micro-controller, application specific integrated circuit or combination of discrete electronic components operable to perform the functions that are described herein.

In one aspect, dock controller 76 is adapted to communicate with camera controller 32 to enable photography of subject object 11. This can be done in a variety of ways. For example, in the embodiment shown in FIGS. 1-3, base 70 is adapted to receive digital camera 12 in a receiving area 71 so that a camera connector 78 in digital camera 12 can connect to a compatible base connector 80 in base 70 to facilitate such communications. In the embodiment shown, digital camera receiving area 71 can have a variety of forms such as each adapted to position digital camera 12 so that lens system 23 is directed at an object mount 100 when digital camera 12 is positioned therein. However, it will be appreciated that communication between docking station controller 76 and camera controller 32 can be effected in a variety of other ways, for example, wireless signals can be exchanged between an optional wireless communication circuit 82 in base 70 and communication module 54 in digital camera 12.

Dock controller 76 is also adapted to communicate with one or more remote devices 90 including a computer, a PDA, a printer, another camera, a web interface, a computer network, a cellular phone, a copy machine, a fax machine, or combinations of these devices by way of either a physical connection 92 such as a Universal Serial Bus port or a wireless connection by way of a wireless communication circuit 82.

As illustrated in FIGS. 1-3, base 70 has an illumination system 84 with a light source 86 and an optional diffusion medium 88 that diffuses light emitted by light source 86 to provide uniform illumination. Examples of light sources 86 that can be used with docking station 10 include, but are not limited to, diffused light flashes, strobes, fixed light sources or color correction light sources, such as those commercially available. Light source 86 can be fixed in a backlighting position or, alternatively, light source 86 can be movable between at least one backlighting position and another lighting position wherein light source 86 supplies light to a front, top, side or other portion of subject object 11. In this regard base 70 and light source 86 can be joined together to permit slideable or other controlled movement therebetween.

Dock controller 76 is further adapted to communicate with a dock user interface 96. Dock user interface 96 can comprise any form of transducer or other device capable of receiving an input from a user and converting this input into a form that can be used by dock controller 76 in operating docking station 10. For example, dock user interface 96 can comprise a touch screen input, a touch pad input, a 4-way switch, a 6-way switch, an 8-way switch, a stylus system, a trackball system, a joystick system, a voice recognition system, a gesture recognition system or other such systems. As shown in the embodiment of FIGS. 1-3, dock user interface 96 includes an Easyshare™ button 97 and a capture button 98 that send signals dock controller 76 when activated.

Docking station 10 can optionally incorporate an output system 99 that provides human perceptible signals when instructed to do so by dock controller 76. Output system 99 can comprise visual output systems such as pixellated displays, segmented display or other displays capable of presenting graphic or video images, so that a user can look at an evaluation image and optionally use user interface 96 to send signals that can be used by dock controller 76 during operation of digital camera 12. In other aspects, output system 99 can provide other forms of visual output signs to a user such as graphic symbols, illuminated lights, text messages and the like using appropriate signaling technology of this type. In still other aspects, output system 99 can comprise audio systems capable of generating human perceptible audio warnings and indications such as simulated human speech, chimes, alerts, music and the like.

Continuing with FIGS. 1-3, docking station 10 includes object mount 100 which is connected to base 70. Object mount 100 is sized to hold a subject object 11 for image capture. Object mount 100, shown in FIGS. 1-3, is adapted for capturing images that are recorded on a light medium 16 of subject object 11. Such a subject object 11 can comprise, for example, a slide, a film negative, or a microfilm.

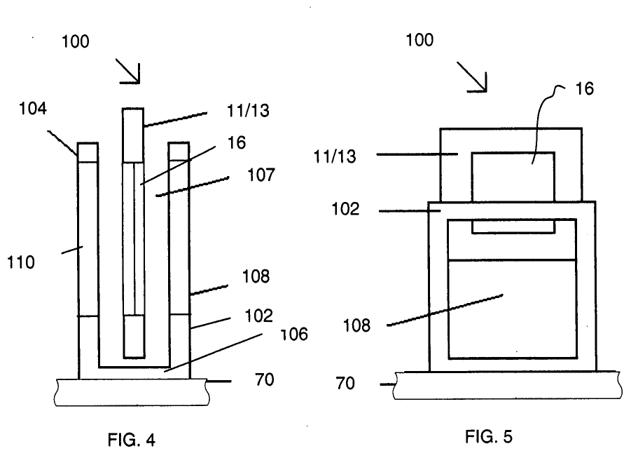

FIG. 4 depicts a side-section view of an embodiment of object mount 100 with subject object 11 having an image recorded on transmissive medium 16. FIG. 5 is a front view of an embodiment of object mount 100, subject object 11, and light transmissive medium 16.

In the embodiment that is illustrated in FIGS. 4 and 5, object mount 100 comprises a front frame 102 and a back frame 104 connected together by linkage 106 and separated by an opening 107. Frames 102 and 104 and linkage 106 can preferably be a one-piece structure, such an injection molded polymer part. Alternatively, frames 102 and 104 can be made as two separate frames that are joined together by linkage 106 with opening 107 formed therebetween into which the image on a light transmissive medium 16, such as a slide or a negative, is placed.

As shown in FIGS. 4 and 5, front frame 102 has a first window 108 and back frame 104 has a second window 110 aligned with the first window 108. Second window 110 can optionally incorporate a light diffusion material to provide uniform illumination for a more even dispersal of light passing through second window 110.

Object mount 100 is typically made from a durable material, including but not limited to, a polypropylene, polyethelene or a static resistant material. Usable metals for the object mount 100 can be coated so that the object mount 100 does not scratch the slide or the negatives disposed in the object mount. Object mount 100 can be adapted to receive and position subject object 11 as shown in FIGS. 4 and 5. Alternatively, object mount 100 can, for example, have a linkage 106 that urges front frame 102 and back frame 104 toward each other to apply a clamping force against subject object 11.

Although in the embodiment of FIGS. 1-5, subject object 11 is illustrated in the form of a slide 13 such as a conventional 35 mm slide. It will be appreciated that other forms of images recorded on a light transmissive medium 16 can be positioned in object mount 100 including, but not limited to a photographic negative, a thin film, a transparency, a photograph, or a drawn image on a light transmissive medium 16 that can be inserted into object mount 100.

As noted above, base 70 has a digital camera receiving area 71 that is adapted to position digital camera 12 with lens system 23 of digital camera 12 directed at object mount 100 and optionally, further directed at light source 86 so that the light emitted from the light source 86 shines though second window 110, then through the image on light transmissive medium 16 then through the first window 108 to lens system 23 of digital camera 12. Digital camera receiving area 71 can be a surface that is adapted to simply allow digital camera 12 to be positioned thereon or it can be more complex with camera holding structures of conventional design provided thereon to provide more support for digital camera 12.

When digital camera 12 is positioned in receiving area 71 on docking station 10, a communication link is established between camera controller 32 and dock controller 76. When camera controller 32 detects such a communication link to dock controller 76, camera controller 32 communicates with dock controller 76 to determine a mode of docked operation. In the embodiment shown in FIGS. 1-5 dock controller 76 and camera controller 32 are operable in one mode to cooperate to facilitate the capture of images of subject object 11 and are further operable in other optional modes to facilitate image and/or other data transfer operations between docking station 10, digital camera 12 and a remote device such as one of remote devices 90 as is commonly done using the Kodak Easyshare™ line of docking stations. Where docking station 10 includes a printer, such as is provided by the Kodak Printer Dock™, or Printer Dock Plus™ printers, camera controller 32 and docking station controller 76 can cooperate to exchange data and to cause images to be printed. Docking station 10 can also be optionally adapted to provide power from power source 72 for operation of digital camera 12 while digital camera 12 is docked thereto and, where applicable to, recharge any rechargeable batteries in digital camera 12. This can be done by way of connectors 78 and 80 or by way of some other connection.

A selection of the docked image capture mode can be made using user input system 34 of digital camera 12 and/or using dock user interface 96. When such a selection is made, camera controller 32 and docking station controller 76 cooperate to initiate a docked image capture process which includes a setup process and an image capture process and can optionally include a composition process and a verification process.

During the setup process, camera controller 32 is adapted to use wired or wireless communications with dock controller 76 to obtain therefrom any data stored therein that can be useful to camera controller 32 in making or determining settings for image capture system 22 and lens system 23 for the capture of an image of subject object 11. In one aspect of the invention, memory 40 contains data that camera controller 32 can use for such setup whenever camera controller 32 detects a communication link to a docked controller 76. This allows camera controller 32 to set exposure settings and other settings for image capture system 22 and/or to make lens settings for lens system 23 when camera controller 32 establishes communication with dock controller 76.

In some embodiments, it may be necessary for camera controller 32 to obtain data characterizing recommended image capture settings from docking station 10 or to obtain data from docking station 10 that camera controller 32 can use to determine appropriate image capture settings. Examples of such data or information include, but are not limited to, data that is indicative of anticipated exposure settings, data that identifies whether the subject image is to be flash photographed or not, data that indicates whether the subject image will be backlit, and data that indicates subject distance information that can be used by camera controller 32 to determine appropriate lens focus or lens distance settings. In still another aspect of the invention, docking station controller 76 can have a memory (not shown) that contains programming data stored therein that is executable by camera controller 32 to allow camera controller 32 to determine settings for image capture system 22 in a manner that is appropriate for image capture in docking station 10. Such executable programming data can provide a permanent update to the camera “firmware” or can simply provide executable programming code that can be executed only while camera 12 is docked in docking station 10.

Camera controller 32 can optionally provide information to dock controller 76 that can help dock controller 76 control docking station 10, including but not limited to, information that will allow dock controller 76 to determine preferred illumination intensities for light source 86. Camera controller 32 can also provide other information to dock controller 76 such as data representing user actuation of user input system 34 as may be useful to dock controller 76. In this way, user input system 34 of camera 12 can be used to provide user input for use by docking station controller 76 without requiring that docking station 10 inherently incorporate such user input systems. Other data that can be provided by camera controller 32 to dock controller 76 includes data that identifies ways in which transferred image data can be shared or otherwise used. Any other form of metadata described herein can also be shared by camera controller 32 with dock controller 76 as may be necessary or useful in executing various functions of docking station 10.

Camera controller 32 has made appropriate settings to image capture system 22 and/or made any other settings for digital camera 12, and dock controller 76 has caused, for example, illumination system 84 to radiate a preferred amount of light for image capture, digital camera 12 can optionally provide the image composition process as generally described above. In the composition process, image capture system 22 captures images and provides these captured images as evaluation images that are presented on display 30 of digital camera 12 and/or optionally on a display is incorporated as part of output system 99. A user can use these evaluation images to verify that the settings determined by camera controller 32 yield evaluation images having an appropriate appearance and, if desired, make any manual adjustments to the settings or to the arrangement of the subject object 11 and image capture system 22. When the user determines that conditions are appropriate, a user can cause an archival image to be captured, for example, by depressing capture button 60 or otherwise using user input system 34 or user interface 96 to send signals to camera controller 32 and/or dock controller 76 from which camera controller 32 can determine need to generate a trigger signal. When this occurs, camera controller 32 generates a trigger signal and image capture system 22 captures a digital archival image. In an optional verification step, an evaluation image that reflects the appearance of the archival image can be presented on display 30 or by any display that is incorporated as part of output system 99 for user review and approval.

The archival image can be stored in memory 40, and/or shared with an external device by way of a removable memory 48, such as a card, or communication module 54. Optionally, the archival image can be communicated to a docking controller 76 which can transmit the captured digital image to a remote device 90 using a connection 92 or using wireless communication circuit 82. Where docking station 10 incorporates a printer as described above, or some other form of printer including, but not limited to, an inkjet printer, a laser printer, an electro-photographic printer or any other form of image printing technology, the captured image can be simultaneously printed.

Camera controller 32 can optionally be adapted to have a recognition feature that allows the camera controller 32 alone or in combination with one of signal processor 26 and/or dock controller 76 to recognize the nature of a subject object 11 during the composition mode. For example, such recognition can help to determine if subject object 11 is a film negative, a slide or a non-transmissive object such as a coin. Such information can be useful in determining exposure settings, or other settings for image capture system 22. Data indicative of such information can be provided to dock controller 76, for example, to allow illumination decisions to be made for operating light source 86.

In one embodiment, camera controller 32 is adapted to receive a signal from a selected input of user input system 34 or user interface 96 and, in response thereto, to automatically execute a setup process for digital camera 12 while dock controller 76 performs a setup process for docking station 10. Camera controller 32 is further adapted to automatically execute an image capture process in response to the signal from the selected input. So that a user can, with a single touch of one button such as capture button 98 or other input, cause an image to be captured of subject object 11 positioned in object mount 100.

Optionally, user interface 96 can be adapted to enable a user to input an address, so that the controller 32 can send the captured image via the network to the designated address or to more than one address input in this manner. The network can be, for example, the Internet, a wireless connection, or phone. In one embodiment of the invention, user interface 96 or user input 34 can have a share or send button that causes an image to be sent via the network to an address so that such an image can be shared with one push of such button. User interface 96 can also be adapted to allow the user to input other information, such as the date of an image of which a digital archival image is being captured, the names of persons in the image captured, the number of related slides corresponding to the captured image, or other such information. Where such information is provided, dock controller 76 and/or camera controller 32 can be adapted to convert such input into metadata and automatically associate this metadata with the archival image, or to apply such information for other uses.

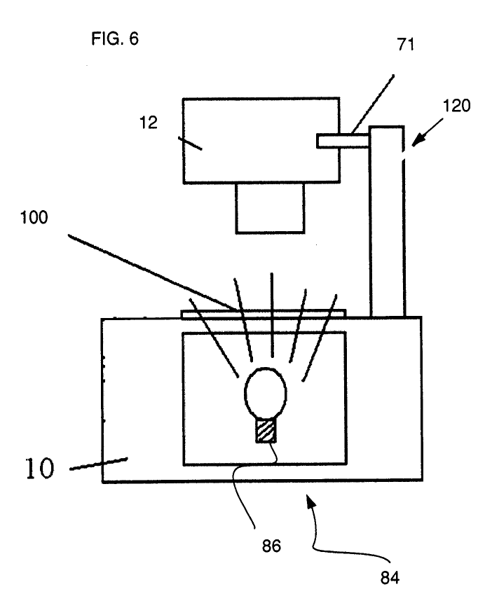

FIG. 6 depicts another embodiment of a docking station 10. In this embodiment, base 70 has a stand 120 with a digital camera receiving area 71 that holds digital camera 12 above base 70 for downward directed image capture. Stand 120 can be adjustable up and down. Base 70 includes an illumination system 84 and light source 86, and an embodiment of object mount 100 for horizontal support of a subject object 11 on base 70. Other features of base 70 are similar to those shown and described with reference to base 70 of FIGS. 1-5. Digital camera 12 can be top mounted, as shown in FIG. 6, or can be mounted beneath light source for a similar vertical mounted embodiment.

In an alternative embodiment, base 70 can have an object mount 100 that is adapted to support a carrier or carousel instead of a flat object mount 100 illustrated in FIG. 6. The carrier holds and stores multiple subject objects 11. In one embodiment, a carrier can be placed over an image holder. An arm (not shown) connected to the base 70 can position the carrier so that various subject objects 11 in the carrier can be accessed. The arm also moves subject objects 11 from the carrier so the selected subject objects can be positioned for capture. This embodiment enables the capturing of multiple images easily by the user. This embodiment is particularly useful for image capture of images that are recorded on slides and stored in a carousel.

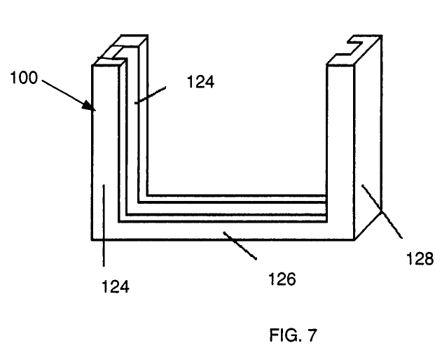

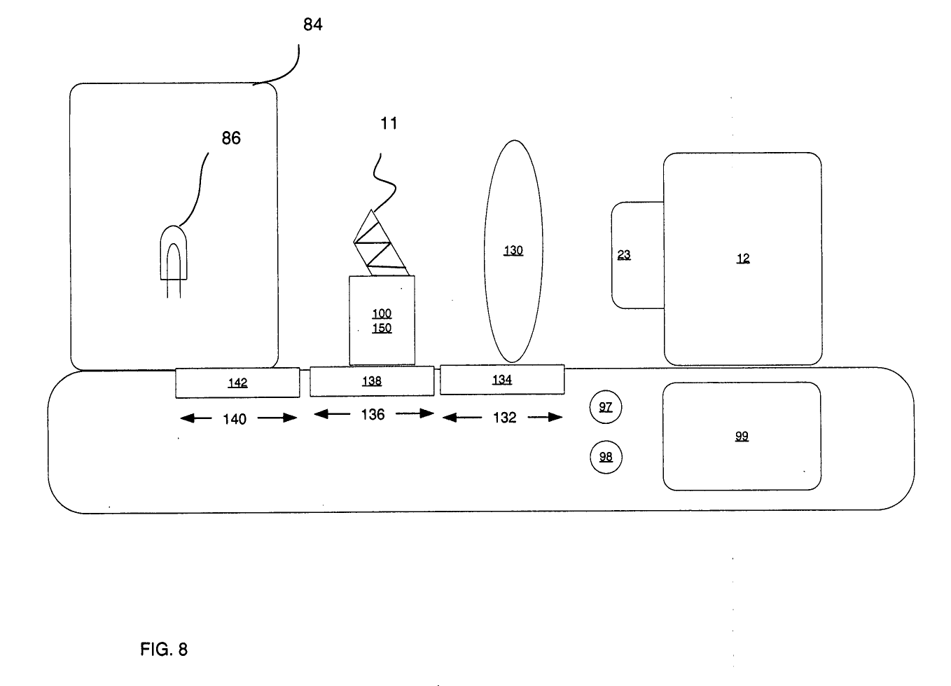

FIG. 7 shows an embodiment of object mount 100 wherein a first slotted post 124 is connected to base 70 or optionally to a slide base 126 that connects to base 70 to hold one end of subject object 11. A second slotted post 128 is connected to the base or optionally to a slide base 126 opposite the first slotted post 124 for holding the other end of subject object 11. The first slotted post 124 and second slotted post 128 form a slot 129 to hold subject object 11.

As shown in FIG. 8, an optional dock optical system 130 can be provided between digital camera 12 and subject object 11 to help focus light traveling from subject object 11 to image capture system 22. Optical system 130 can be used for a variety of purposes, for example, to extend the lens positioning and thereby increase its magnifying power. Optical system 130 can comprise an extension tube, extendable in various fixed lengths to provide different magnifications. While it has been known in the art to use extension tube and bellows systems to adapt a camera to capture an image of a near object, the use of such a system for near-image capture has traditionally been the province of the advanced user as the task, of determining proper image capture settings for capturing an image with such a system, requires experience that is often beyond the exposure level of conventional camera users. It will be appreciated that the use of such an embodiment of dock optical system 130 with docking station 10 of the invention is brought into the realm of the casual photographer in that such settings can automatically be made without requiring any particular understanding on the part of the user.

Dock optical system 130 can include a macro lens such as the popular macro lenses used with 35 mm single lens reflex cameras that have, in that application focal lengths of around 50 mm. Such a macro lens works in combination with lens system 23 to permit lens extension until the subject object 11 is enlarged to about a preferred size on image sensor 24. Such a macro lens can be adapted to have special “flat-field” optics so that it can be used to copy flat, 2-dimensional subject such as stamps, pictures, slides, transparencies and other two-dimensional objects without distorting them. As is known in the art, such a macro lens typically has a relatively small maximum aperture which limits use of such a macro-lens to fairly high light image capture situations. However, unless instructed otherwise, a controller 32 for digital camera 12 will typically make adjustments to exposure settings assuming that such a macro lens system is not present.

In other embodiments where such a macro-lens is provided without being adapted with flat field optics, docking station controller 76 can provide data to camera controller 32 that causes camera controller 32 and/or signal processor 26 to apply digital processing methods such as well known edge sharpening algorithms, when appropriate, to simulate the effects of the use of a macro-lens that is adapted with flat field optics.

Dock optical system 130 can also incorporate filters as required to enhance the appearance of the image. Here too, the use of such filters can trigger the need to adjust image capture settings in ways that may not be apparent to a casual user within normal operating parameters to a conveniently programmed digital camera.

Accordingly, the use of a conventional digital camera 12 with a dock optical system 130 requires user intervention to define exposure and other parameters that ensure that camera controller 32 is adapted to provide images that have exposure levels that are acceptable to a user.

In accordance with one embodiment of the invention, when camera controller 32 and docking station controller 76 determine that an image is to be captured in the near-photography mode using light that has been modified by a dock optical system 130, camera controller 32 and docking station controller 76 can cooperate to determine appropriate camera exposure settings based upon prior analysis of the effects of the dock optical system 130, and known characteristics of lens system 23. Optionally, camera controller 32 and dock controller 76 can be adapted to determine appropriate light output patterns or settings for light source 86 to ensure that, during image capture, the near object is illuminated in a manner that permits image capture system 22 of digital camera 12 to capture an image having a desired appearance.

In the embodiment of FIG. 8, optical system 130 is optionally adjustable along a path 132 and, as shown in this embodiment, the docking station 10 has optical system sensors 134 to detect the current adjustments of optical system 130 and provide a signal to dock controller 76. This allows dock controller 76 to generate data that is indicative of the current adjustments so that image capture setting determinations, or other determinations, can be made based upon such adjustments.

Similarly, as shown in FIG. 8, docking station 10 has an object mount 100 that is adjustable along a path 136 and a position sensor 138 that can detect the adjustment of object mount 100 along path 138, and ca provide a signal to dock controller 76 that allows dock controller 76 to generate data that is indicative of the current adjustments of object mount 100. This allows dock controller 76 to generate data that is indicative of the current adjustments of object mount 100 so that an image setting can be determined based thereon.

Similarly, as shown in FIG. 8, docking station 10 has an illumination system 84 that is adjustable along a path 140 and a position sensor 142 that can detect the adjustment of illumination system 84 along path 140, and can provide a signal to dock controller 76 that allows dock controller 76 to generate data that is indicative of the current adjustments of illumination system 84. This allows dock controller 76 to generate data that is indicative of the current adjustments of illumination system 84 so that an image setting can be determined based thereon. Docking station 10 can incorporate a wide variety of features and options. In one embodiment of the invention, docking station 10 can be provided as a part of a conventional kiosk system, such as the Photomaker Kiosk sold by Eastman Kodak Company, Rochester, N.Y., U.S.A., or in combination with such a system.

Further, it will be appreciated that while object mount 100 has been illustrated as comprising a holder type of object mount 100, in other embodiments object mount 100 can comprise a surface 150, such as a pedestal, or other type of structure capable of receiving subject object 11 and positioning subject object 11 so that a near object image can be captured thereof by a digital camera 12 positioned in digital camera receiving area 71.

The invention has been described in detail with particular reference to certain preferred embodiments thereof, but it will be understood that variations and modifications can be effected within the spirit and scope of the invention.

### PARTS LIST

10 docking station
11 subject object
12 digital camera
13 slide
16 light transmissive medium
20 body
22 image capture system
23 lens system
24 image sensor
25 driver
26 signal processor
27 rangefinder system
28 display driver
30 display
32 camera controller
34 user input system
36 sensors
38 viewfinder system
40 memory
46 memory card slot
48 removable memory
50 removable memory interface
52 remote memory system
54 communication module
60 capture button
66 print-it button
67 mode selector button
68 edit button
70 base
71 digital camera receiving area
72 power source
76 docking station controller
78 camera connector
80 base connector
82 wireless communication circuit
84 illumination system
86 light source
88 diffusion medium
90 remote device
92 connection
96 user interface
97 share button
98 capture button
99 output system
100 object mount
102 front frame
104 back frame
106 linkage
108 first window
110 second window
120 stand
124 slotted post
126 slide base
128 second slotted post
129 slot
130 dock optical system
132 path
134 dock optical system sensor
136 path
138 position sensor
140 path
142 position sensor
150 surface

1. A docking station comprising:
a base having a digital camera receiving area adapted to position a digital camera so that the digital camera is directed at an object mount, said object mount adapted to position a subject object at a distance of less than one meter from a lens system of the digital camera; and
a communication circuit adapted to exchange data between the dock controller and a camera controller in the digital camera when the digital camera is in the digital camera receiving area;
wherein said exchange of data causes the camera controller to adapt settings of an image capture system in the camera for the capture of an image of the subject object.

2. The docking station of claim 1, further comprising an illumination system adapted to radiate light in response to control signals from the dock controller, said dock controller being adapted to determine the characteristics of the light to be radiated by the light source based upon data exchanged with the camera controller and to generate control signals that cause the determined light to be generated.

3. The docking station of claim 1, wherein the dock controller provides data containing instructions that are executable by the camera controller to determine at least one setting for the image capture system.

4. The docking station of claim 1, wherein the dock controller provides data containing instructions that are executable by the camera controller to determine a setting for the image capture system based a determined type of subject image.

5. The docking station of claim 1, wherein the dock controller provides data that can be used by the camera controller to determine a setting for an adjustable lens system of the image capture system.

6. The docking station of claim 1, wherein the dock controller provides data that can be used by the camera controller to determine an exposure setting for the image capture system.

7. The docking station of claim 1, further comprising an optical system adapted to modify light passing from the subject object to the lens system of the image capture system, and wherein said exchanged data includes data that characterizes the modification of the light caused by the optical system, said data being usable to determine an image capture setting.

8. The docking station of claim 7, wherein said optical system is adjustable and wherein said docking station has at least one sensor to detect the current adjustments of the optical system and wherein said exchanged data is indicative of the current adjustments so that image capture settings can be made based upon such adjustments.

9. The docking station of claim 1, further comprising a switch disposed on the base, with the switch being adapted to receive a user actuation, and to transmit a signal to the docking controller so that the dock controller exchanges data with the digital camera that causes image capture settings to be determined, illumination to be supplied by the illumination source and an image to be captured using the determined image capture settings without further user actuation of the digital camera or docking station.

10. A docking station for using a digital camera to capture an image of an image recorded on a light transmissive medium, wherein the docking station comprises:
a base having a first end and a second end;
an object mount connected to the base between the first and second end, said object mount having a holding frame that is adapted to hold the light transmissive medium;
a light source at the first end, and adapted to illuminate the object mount in an area where the object mount will hold the light transmissive medium;
a digital camera receiving area adapted to position the digital camera so that the digital camera is directed to capture an image of the image recorded on the light transmissive medium; and
a communication circuit adapted to enable data to be exchanged between a digital camera controller in the digital camera and a dock controller,
with said dock controller and digital camera controller being adapted to exchange data and to use the exchanged data to cause the light source to illuminate the image on the light transmissive medium and to cause the digital camera to be set to capture an image of the image on the light transmissive medium.

11. The docking station of claim 10, wherein base further comprises a communication circuit adapted to communicate with an external device.

12. The docking station of claim 10, wherein the docking station is in communication with a plurality of output devices.

13. The docking station of claim 10, further comprising a switch disposed on the base, with the switch being adapted to receive a user actuation, and to transmit a signal to the dock controller so that the dock controller exchanges data with the digital camera controller that causes image capture settings to be determined, illumination to be supplied by the illumination source and an image to be captured without further user actuation of the digital camera or docking station.

14. The docking station of claim 1, further comprising a user interface connected to the dock controller, wherein the user interface is adapted to send an address to the dock controller so the dock controller and camera controller cooperate to transmit the captured image from the docking station to the address.

15. The docking station of claim 14, wherein the captured image is transmitted using at least one of a wired telecommunication network, the Internet, a wireless telecommunication network or other wireless network.

16. The docking station of claim 15, wherein the captured image is transmitted to an output device comprising at least one of a printer, a computer, a PDA, a cellular phone, a copy machine, a fax machine or combinations thereof.

17. The docking station of claim 10, wherein the image on transmissive medium is at least one of a 35 mm slide, a photographic negative, a thin film, a transparency, or a photograph.

18. The docking station of claim 10, wherein the light source is at least one of a lamp, a flash tube, a diffused light flash or a color correction light source.

19. The docking station of claim 10, wherein the digital camera is a movie camera, digital still camera, video camera, or combinations thereof, and wherein the digital image capture device is capable, in combination with the docking station, of capturing an image of the subject object having a printable image resolution of at least between 100 and 1000 dpi.

20. The docking station of claim 10, wherein the digital camera is, at least in part, integrated into the base.

21. A docking station for transferring images on light transmissive mediums using a digital camera, wherein the docking station comprises:
a base connected to a power source;
an object mount connected to the base adapted to hold a light transmissive medium having an image recorded thereon;
a light source disposed within the base adapted to illuminate the image on a light transmissive medium;
a stand comprising a top end and a bottom end, wherein the bottom end is connected to the base;
a digital camera connected to the top end, wherein the digital camera is positioned to capture the image on a light transmissive medium illuminated in the object mount; and
a controller connected to the base, wherein the controller is adapted to perform at least three operations:
a first operation to cause the digital camera to set up an image capture system to capture an image of the image on the light transmissive medium;
a second operation to illuminate the image on a light transmissive medium using the light source; and
a third operation to allow the digital camera to communicate with an output device once the image on a light transmissive medium is captured digitally.

22. The docking station of claim 21, wherein the output device is a printer.

23. The docking station of claim 21, wherein the docking station is in communication with a plurality of output devices.

24. The docking station of claim 21, further comprising a switch disposed on the base, wherein the switch is adapted to cause the controller to set at least one image capture setting for capturing an image of the image on the light transmissive medium, to cause a lighting intensity for the light source to be set, and to further cause an image to be captured of the image on a light transmissive medium simultaneously.

25. The docking station of claim 21, further comprising a user interface connected to the controller and engaging a network, wherein the user interface is adapted to send an address to the controller so the controller transmits the image on a light transmissive medium from the docking station to the address.

26. The docking station of claim 21, wherein the network is an Internet, a wireless device, or a phone.

27. The docking station of claim 21, wherein the object mount is a one piece molded material.

28. The docking station of claim 21, wherein the image on a light transmissive medium is a 35 mm slide, a photographic negative, a thin film, a transparency, or a photograph.

29. The docking station of claim 21, wherein the output device is a printer, a computer, a PDA, a cellular phone, a copy machine, a fax machine or combinations thereof.

30. The docking station of claim 21, wherein the digital image capture device is a movie camera, digital camera, video camera, or combinations thereof, wherein the digital image capture device comprises a resolution above 1000 dpi.

31. The docking station for use with a digital camera comprising:
a base means having a digital camera receiving means for directing a digital camera at an object mount means; said object mount means for positioning a subject object at a distance of less than one meter from an image capture means of the digital camera;
a communication means for exchanging data between a dock control means and a camera control means in the digital camera;
wherein said exchange of data causes the camera control means to adapt the image capture means in the digital camera for the capture of an image of the subject object.

32. The docking station of claim 31, wherein the object mount comprises at least one of a pedestal, plateau, curved surface, or other surface generally shaped to allow the subject object to rest thereupon in a position that enables the digital camera to capture an image thereof when the digital camera is positioned in the receiving means.

33. The docking station of claim 31, further comprising a share button and a control means adapted to sense when the share button is depressed and to cause an image captured by the digital camera to be transmitted to another device.

34. The docking station of claim 31, further comprising a dock optical system adapted to adjust light passing from the subject object to the digital camera, wherein said exchange of data includes data that the camera control means can use to adjust the image capture means to cooperate with the dock optical means.

35. The docking station of claim 31, wherein the exchange of data includes data that the camera control means can use to select an image processing algorithm or to execute an image processing algorithm.
